(19) United States
(12) Patent Application Publication
(10) Pub. No.: US 2025/0218035 A1
(43) Pub. Date: Jul. 3, 2025

(54) ROADSIDE APPARATUS AND NOTIFICATION METHOD

(71) Applicant: TOYOTA JIDOSHA KABUSHIKI KAISHA, Toyota-shi (JP)

(72) Inventors: Toshiki KASHIWAKURA, Tokyo-to (JP); Chihiro INABA, Tokyo-to (JP); Shoi SUZUKI, Tokyo-to (JP); Tsuyoshi OKADA, Nagoya-shi (JP); Yasuhiro KOBATAKE, Nagoya-shi (JP)

(73) Assignee: TOYOTA JIDOSHA KABUSHIKI KAISHA, Toyota-shi (JP)

(21) Appl. No.: 18/985,458

(22) Filed: Dec. 18, 2024

(30) Foreign Application Priority Data
Dec. 28, 2023 (JP) 2023-223250

(51) Int. Cl. G06T 7/73; G06T 7/00; G08B 21/18

(52) U.S. Cl. CPC G06T 7/74; G06T 7/0002; G08B 21/182; G06T 2207/30236; G06T 2207/30244

(57) ABSTRACT

A roadside apparatus includes a controller configured to store a reference image captured with the roadside apparatus installed in a reference posture, calculate an amount of deviation between a capturing range of an image captured after the reference image is stored and a capturing range of the reference image, and notify a server of information encouraging a repair to a posture of the roadside apparatus in a case in which the amount of deviation is equal to or greater than a threshold.

### CROSS-REFERENCE TO RELATED APPLICATION

This application claims priority to Japanese Patent Application No. 2023-223250 filed on Dec. 28, 2023, the entire contents of which are incorporated herein by reference.

### TECHNICAL FIELD

The present disclosure relates to a roadside apparatus and a notification method.

### BACKGROUND

Technology for notifying pedestrians and vehicles of information is known. For example, Patent Literature (PTL) 1 discloses a notification system that, according to the behavior of an automated driving vehicle scheduled to pass through a predetermined traffic area, notifies vehicles other than the automated driving vehicle, pedestrians, and the like of whether they can pass through, warning information, or the like.

### CITATION LIST

### Patent Literature

PTL 1: JP 2023-050629 A

### SUMMARY

A roadside apparatus can be installed at any location and provides a notification upon detecting a pedestrian from the video of a camera mounted on the roadside apparatus. Here, if the orientation of the roadside apparatus changes after installation unintentionally for some reason, such as a pedestrian or the like hitting the roadside apparatus, for example, the angle of view or capturing range of the camera may change, and the accuracy of pedestrian detection may be reduced. Therefore, there is room for improvement with respect to technology for notifying pedestrians and vehicles of information.

It would be helpful to improve technology for notifying pedestrians and vehicles of information.

A roadside apparatus according to an embodiment of the present disclosure is a roadside apparatus including:
a notification interface;
an imager;
a memory; and
a controller configured to:
   store in the memory a reference image captured by the imager with the roadside apparatus installed in a reference posture;
   calculate an amount of deviation between a capturing range of an image captured by the imager after the reference image is stored and a capturing range of the reference image; and
   notify a server of information encouraging a repair to a posture of the roadside apparatus via the notification interface in a case in which the amount of deviation is equal to or greater than a threshold.

A notification method according to an embodiment of the present disclosure is a notification method performed by a roadside apparatus, the notification method including:
storing a reference image captured with the roadside apparatus installed in a reference posture;
calculating an amount of deviation between a capturing range of an image captured after the reference image is stored and a capturing range of the reference image; and
notifying a server of information encouraging a repair to a posture of the roadside apparatus in a case in which the amount of deviation is equal to or greater than a threshold.

According to an embodiment of the present disclosure, technology for notifying pedestrians and vehicles of information is improved.

### BRIEF DESCRIPTION OF THE DRAWINGS

In the accompanying drawings:

FIG. 1 is a block diagram illustrating a schematic configuration example of a system according to an embodiment of the present disclosure;

FIG. 2 is a flowchart illustrating an example of operations of a roadside apparatus;

FIG. 3 is a schematic diagram illustrating an example of installation of the roadside apparatus;

FIG. 4 is a schematic diagram illustrating an example of a posture of the roadside apparatus;

FIG. 5 is a schematic diagram illustrating a capturing range of an image; and

FIG. 6 is a schematic diagram illustrating an amount of deviation of the capturing range of the image.

### DETAILED DESCRIPTION

Hereinafter, an embodiment of the present disclosure will be described.

### Outline of Embodiment

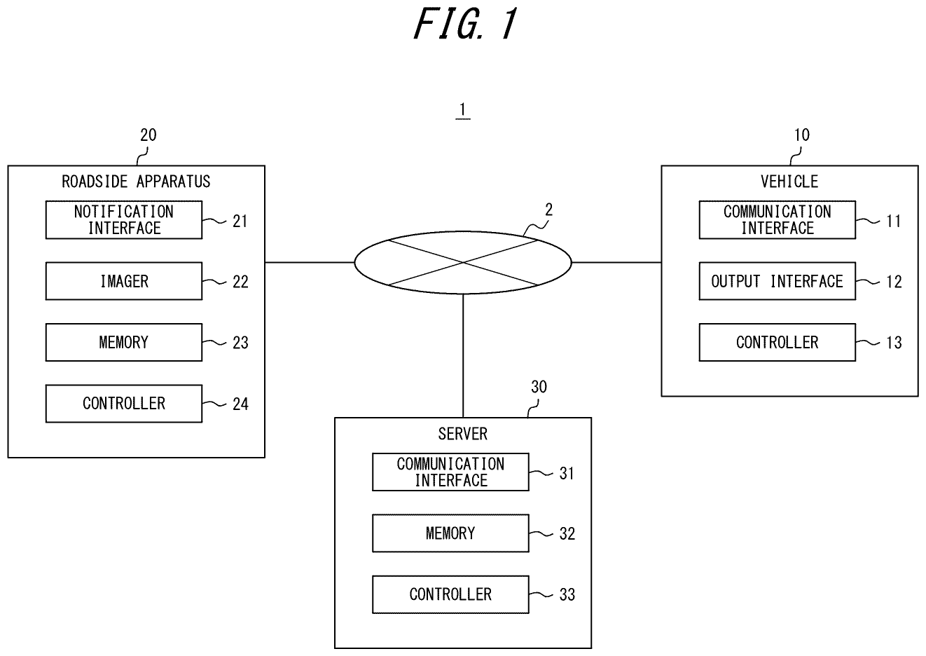

An outline of a system 1 according to an embodiment of the present disclosure will be described with reference to FIG. 1. The system 1 includes a vehicle 10, a roadside apparatus 20, and a server 30. The vehicle 10, the roadside apparatus 20, and the server 30 are communicably connected with a network 2 including, for example, the Internet, a mobile communication network, and the like.

The vehicle 10 is an automobile, for example, but is not limited to this and may be any appropriate vehicle. The automobile is a gasoline vehicle, a battery electric vehicle (BEV), a hybrid electric vehicle (HEV), a plug-in hybrid electric vehicle (PHEV), a fuel cell electric vehicle (FCEV), or the like, but is not limited to these. In this disclosure, the vehicle 10 shall be an automated driving vehicle 10 with an automated driving function. However, the vehicle 10 is not limited to the automated driving vehicle 10. The number of automated driving vehicles 10 included in the system 1 may be freely determined. The automated driving vehicle 10 is communicably connected to the roadside apparatus 20 via the network 2.

The roadside apparatus 20 is an information communication apparatus that, upon detecting a pedestrian heading toward the roadway from a camera video, notifies the pedestrian and also notifies the automated driving vehicle approaching the pedestrian. The roadside apparatus 20 also notifies the server 30 of information encouraging a repair to the posture of the roadside apparatus 20. The roadside apparatus 20 is communicably connected to the automated driving vehicle 10 and the server 30 via the network 2.

The server 30 is a computer owned by the administrator (the management center) of the roadside apparatus 20. The server 30 communicates with the roadside apparatus 20 via the network 2.

First, an outline of the present embodiment will be described, and details thereof will be described later. The roadside apparatus 20 stores in a memory 23 a reference image captured by an imager 22 with the roadside apparatus 20 installed in a reference posture, calculates an amount of deviation between a capturing range of an image captured by the imager 22 after the reference image is stored and a capturing range of the reference image, and notifies the server 30 of information encouraging a repair to a posture of the roadside apparatus 20, via a notification interface 21, in a case in which the amount of deviation is equal to or greater than a threshold.

Thus, the roadside apparatus 20 notifies the server 30 of information encouraging a repair to the posture of the roadside apparatus 20 if the amount of deviation between the capturing range of the captured image and the capturing range of the reference image is equal to or greater than a threshold. The administrator of the server 30 who has received the notification recognizes the posture change that has occurred in the roadside apparatus 20 at an early stage, and can take prompt action, for example, by returning the posture of the roadside apparatus 20 to the reference posture. Thus, the technology for notifying pedestrians and vehicles of information is improved in that the accuracy of detecting pedestrians heading toward the roadway is increased.

Next, configurations of the system 1 will be described in detail.

### (Configuration of Vehicle)

As illustrated in FIG. 1, the vehicle 10 (the automated driving vehicle 10) includes a communication interface 11, an output interface 12, and a controller 13.

The communication interface 11 includes at least one interface for communication for connecting to the network 2. The communication interface is compliant with a mobile communication standard such as the 4th generation (4G) standard or the 5th generation (5G) standard, an in-vehicle network (e.g., a Controller Area Network (CAN)), or the like, for example, but is not limited to these. In the present embodiment, the automated driving vehicle 10 communicates with the roadside apparatus 20 via the communication interface 11 and the network 2.

The output interface 12 is configured with at least one audio output interface that can output audio, and at least one display interface that can display text or video. The interface for audio output is, for example, a speaker that outputs information received from the roadside apparatus 20 by audio. The display interface is, for example, a display such as an LCD or organic EL display that outputs map information or information received from the roadside apparatus 20 in the form of text or video. However, the audio output interface and the display interface are not limited to these.

The controller 13 includes at least one processor, at least one programmable circuit, at least one dedicated circuit, or a combination of these. The processor is a general purpose processor such as a central processing unit (CPU) or a graphics processing unit (GPU), or a dedicated processor that is dedicated to specific processing, for example, but is not limited to these. The programmable circuit is a field-programmable gate array (FPGA), for example, but is not limited to this. The dedicated circuit is an application specific integrated circuit (ASIC), for example, but is not limited to this. The controller 13 controls operations of the entire automated driving vehicle 10.

### (Configuration of Roadside Apparatus)

As illustrated in FIG. 1, the roadside apparatus 20 includes the notification interface 21, the imager 22, the memory 23, a controller 24, and a strut 20A.

The notification interface 21 includes at least one interface for communication for connecting to the network 2. The communication interface may be compliant with, for example, mobile communication standards, wired local area network (LAN) standards, or wireless LAN standards, but these examples are not limiting. The communication interface may be compliant with any appropriate communication standards. In the present embodiment, the roadside apparatus 20 communicates with the automated driving vehicle and the server 30 via the notification interface 21 and the network 2.

Furthermore, the notification interface 21 includes at least one of the following: (i) a speaker that informs pedestrians of the approach of the automated driving vehicle 10 by audio; (ii) a display that informs the pedestrians of the approach in the form of text or video; and (iii) a signal light that informs the pedestrians of the approach by flashing light, but a method of notifying the information is not limited to these.

The imager 22 is equipped with a video camera 22A, which captures moving images or still images of pedestrians heading toward the roadway.

The memory 23 includes one or more memories. The memories included in the memory 23 may each function as, for example, a main memory, an auxiliary memory, or a cache memory. The memory 23 stores any information to be used for operations of the roadside apparatus 20. For example, the memory 23 may store system programs, application programs, databases, images captured by the imager 22, and the like. The information stored in the memory 23 may be updated with, for example, information acquired from the network 2 via the notification interface 21.

The controller 24 includes at least one processor, at least one programmable circuit, at least one dedicated circuit, or a combination of these. The controller 24 controls operations of the entire roadside apparatus 20.

The strut 20A is a strut used to support the roadside apparatus 20 (the notification interface 21, the imager 22, the memory 23, and the controller 24). The strut 20A is installed on the roadside strip of the roadway, but the installation location is not limited to this.

### (Configuration of Server)

As illustrated in FIG. 1, the server 30 includes a communication interface 31, a memory 32, and a controller 33.

The communication interface 31 includes at least one interface for communication for connecting to the network 2. The communication interface may be compliant with, for example, mobile communication standards, wired local area network (LAN) standards, or wireless LAN standards, but these examples are not limiting. The communication interface may be compliant with any appropriate communication standards. In the present embodiment, the server 30 communicates with the roadside apparatus 20 via the communication interface 31 and the network 2.

The memory 32 includes one or more memories. The memories included in the memory 32 may each function as, for example, a main memory, an auxiliary memory, or a cache memory. The memory 32 stores any information used for operations of the server 30. For example, the memory 32 may store a system program, an application program, a database, information on the roadside apparatus 20 to be managed, and the like. The information stored in the memory 32 may be updated with, for example, information acquired from the network 2 via the communication interface 31.

The controller 33 includes at least one processor, at least one programmable circuit, at least one dedicated circuit, or a combination of these. The controller 33 controls the operations of the entire server 30.

### (Flow of Operations of Roadside Apparatus)

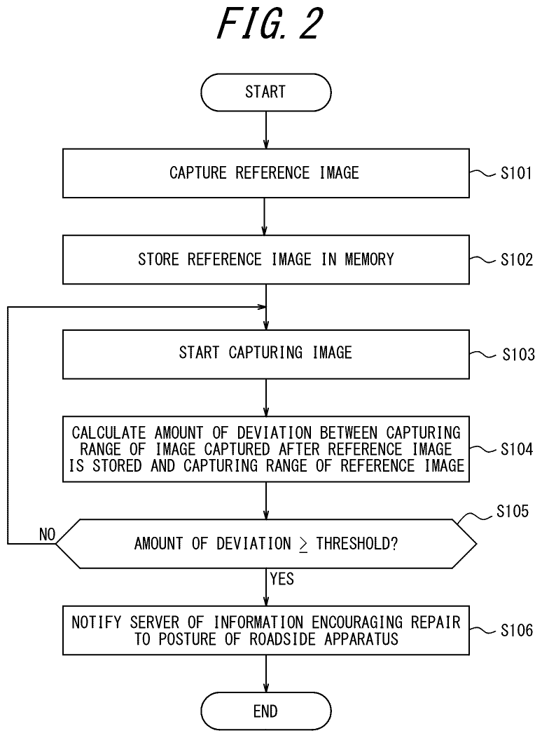

Operations of the roadside apparatus 20 according to the present embodiment will be described with reference to FIG. 2. These operations relate to the notification of information encouraging a repair to the posture of the roadside apparatus 20.

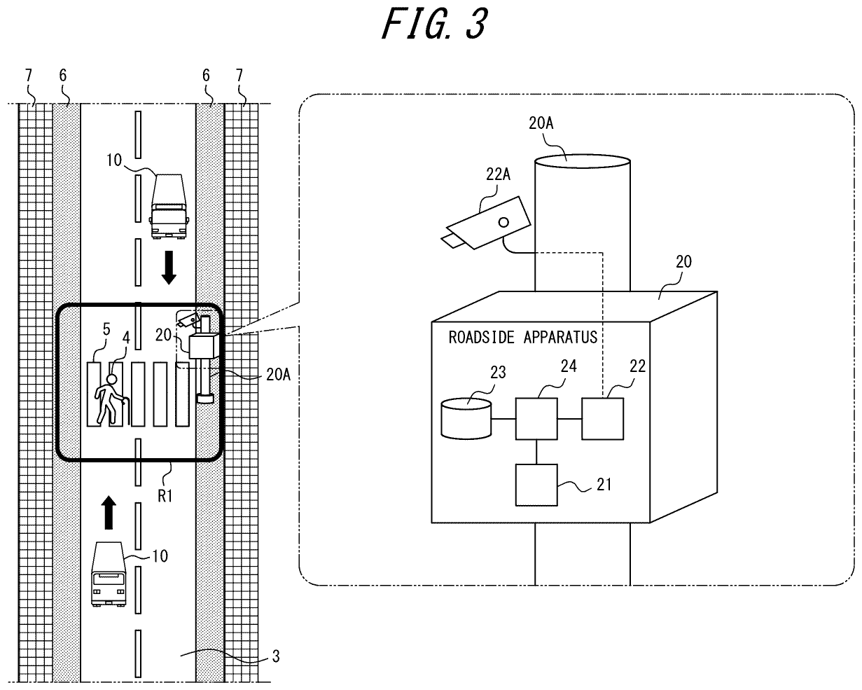

FIG. 3 is a schematic diagram illustrating an example of installation of the roadside apparatus. As illustrated in FIG. 3, the automated driving vehicle travels on a roadway 3 and a pedestrian 4 crosses the roadway 3 at a crosswalk 5 or the like. The roadside apparatus 20 can be installed at any location. In the example illustrated in FIG. 3, the roadside apparatus 20 is mounted on the strut 20A installed on a roadside strip 6 of the roadway 3, for example, in the vicinity of the crosswalk 5. The imager 22 of the roadside apparatus 20 is equipped with the video camera 22A. The position and orientation of the video camera 22A is adjusted to allow detection of pedestrians 4 heading toward the roadway.

S101-S102: The controller 24 stores in the memory 23 the reference image captured by the imager 22 (the video camera 22A) with the roadside apparatus 20 installed in the reference posture.

The imager 22 (the video camera 22A) captures moving images or still images of the pedestrian 4 heading toward the roadway 3. In the example in FIG. 3, the video camera 22A is, for example, mounted on the strut 20A installed on the roadside strip 6 of the roadway 3, but the mounting location may be any location on the strut 20A.

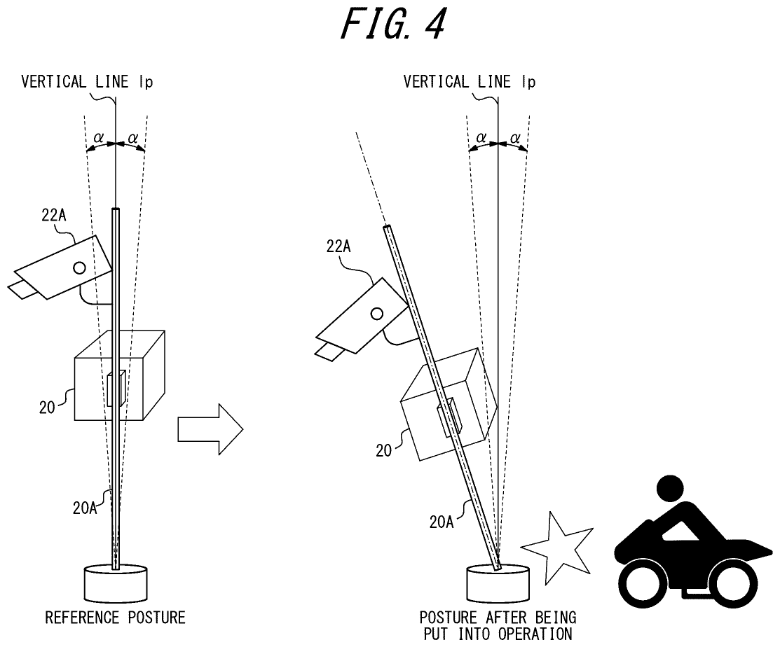

FIG. 4 is a schematic diagram illustrating an example of a posture of the roadside apparatus 20. As illustrated in FIG. 4, in this disclosure, the reference posture is a posture of the strut 20A supporting the roadside apparatus 20, in which the strut 20A points in a vertical direction 1p. However, the strut 20A may be erected with a predetermined tolerance a in the circumferential direction from the vertical direction 1p. The video camera 22A mounted on the strut 20A erected in such a basic posture is adjusted to a position and orientation that allows for a capturing range R1 to detect the pedestrian 4 heading toward the roadway 3. As illustrated in FIG. 4, when the posture of the strut 20A changes from the basic posture due to a vehicle (motorcycle) collision or the like, the capturing range of the video camera 22A shifts (changes) accordingly.

S103: The imager 22 starts capturing images.

The controller 24 starts capturing images after the reference image is stored. The controller 24 may store the captured images in the memory 23 each time the imager 22 captures an image.

S104: The controller 24 calculates the amount of deviation between the capturing range of the image captured by the imager 22 (the video camera 22A) after the reference image is stored and the capturing range of the reference image.

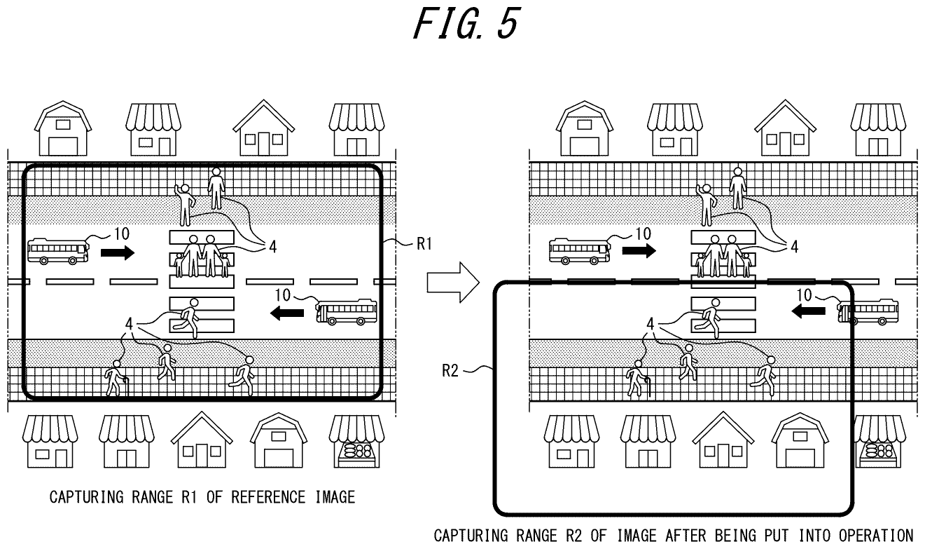

FIG. 5 is a schematic diagram illustrating a capturing range of an image. The capturing range R1 of the reference image at the time of installation, illustrated in the left figure of FIG. 5, may shift to the capturing range R2 due to changes in the posture of the strut 20A caused by some unintended factor after the roadside apparatus 20 is put into operation. The unintended factors may include, for example, factors such as vehicle collision or pedestrian contact as illustrated in FIG. 4, but are not limited to these. Such a shift in the capturing range may reduce the accuracy of detecting pedestrians 4. For example, in the example illustrated in FIG. 5, if the capturing range is shifted to R2, the pedestrians 4 (a family of four) crossing the crosswalk 5 will be outside the capturing range R2 and cannot be detected.

S105: The controller 24 determines whether the amount of deviation A is equal to or greater than the threshold X.

The amount of deviation λ is the percentage (%) obtained by dividing the area of the range in which the capturing range R2 of the image captured by the imager 22 after the reference image is stored does not overlap with the capturing range R1 of the reference image (the range in which R2 is out of alignment with R1), by the area of the capturing range R1 of the reference image. The threshold X is set, for example, at 20%, but the set value is not limited to 20%.

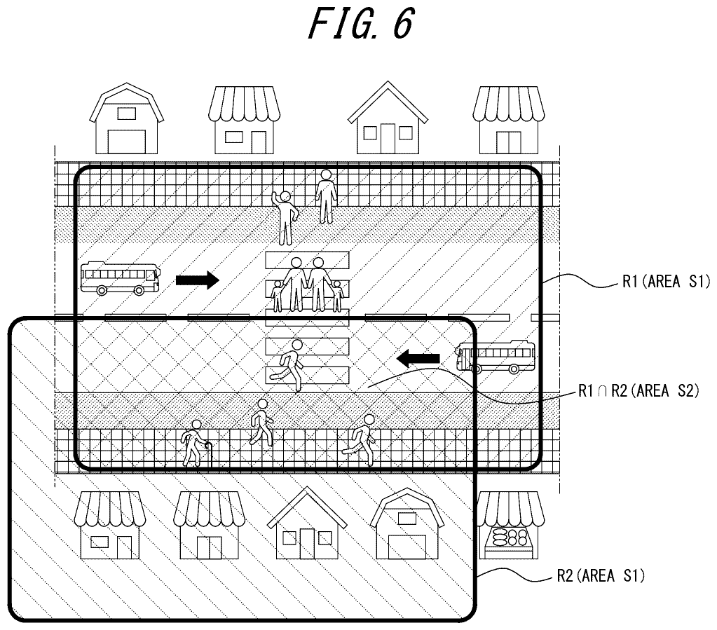

FIG. 6 is a schematic diagram illustrating an amount of deviation λ of the capturing range of the image. Suppose that, as illustrated in FIG. 6, the capturing range R1 of the reference image is shifted to the capturing range R2 due to some factor during the operation of the roadside apparatus 20. In such a case, if the area of the capturing ranges R1 and R2 is S1 and the area where the capturing ranges R1 and R2 overlap with each other is S2, the amount of deviation λ (%) is calculated based on the following formula (1).

$$λ = ( S 1 - S 2 ) / S 1 \qquad ( 1 )$$

The controller 24 determines whether the amount of deviation λ (%) is equal to or greater than the threshold X (%) based on the following formula (2).

$$λ \geq X \qquad ( 2 )$$

S106: The controller 24 notifies the server 30 of the information encouraging a repair to the posture of the roadside apparatus 20 via the notification interface 21 if the amount of deviation A is equal to or greater than the threshold X.

The administrator of the server 30 who has received the notification can recognize the posture change that has occurred in the roadside apparatus at an early stage and can take prompt action, for example, to return the posture of the roadside apparatus 20 to the reference posture. Furthermore, the controller 24 may temporarily store the captured images in the memory 23 each time the imager 22 captures an image. The controller 24 may transmit to the server 30 an image at the time when the amount of deviation A exceeds the threshold X and an image immediately before the amount of deviation A exceeds the threshold X, in order for the administrator of the server 30 to identify the factors causing the deviation in the posture of the roadside apparatus 20.

On the other hand, the controller 24 may continue capturing images using the imager 22 if the amount of deviation A is less than the threshold X. The controller 24 may also use image processing to correct for misalignment in the captured image. Misalignment correction improves the accuracy of the captured image, which further improves the accuracy of detecting the pedestrian 4.

As described above, the roadside apparatus 20 according to the present embodiment stores in the memory 23 a reference image captured by the imager 22 with the roadside apparatus 20 installed in a reference posture, calculates an amount of deviation λ between a capturing range R2 of an image captured by the imager 22 after the reference image is stored and a capturing range R1 of the reference image, and notifies the server 30 of information encouraging a repair to a posture of the roadside apparatus 20 via the notification interface 21 in a case in which the amount of deviation A is equal to or greater than a threshold X.

According to such a configuration, the roadside apparatus 20 notifies the server 30 of the information encouraging a repair to the posture of the roadside apparatus 20 when the amount of deviation A between the capturing range R2 of the captured image and the capturing range R1 of the reference image is equal to or greater than the threshold X. The administrator of the server 30 who has received the notification recognizes the posture change that has occurred in the roadside apparatus 20 at an early stage, and can take prompt action, for example, by returning the posture of the roadside apparatus to the reference posture. Thus, the technology for notifying pedestrians 4 and vehicles 10 of information is improved in that the accuracy of detecting pedestrians 4 heading toward the roadway 3 is improved.

While the present disclosure has been described with reference to the drawings and examples, it should be noted that various modifications and revisions may be implemented by those skilled in the art based on the present disclosure. Accordingly, such modifications and revisions are included within the scope of the present disclosure. For example, functions or the like included in each component, each step, or the like can be rearranged without logical inconsistency, and a plurality of components, steps, or the like can be combined into one or a single component, step, or the like can be divided.

For example, an embodiment in which the configuration and operations of the roadside apparatus 20 in the above embodiment are distributed to multiple computers capable of communicating with each other can be implemented. For example, an implementation in which some or all of the components of the roadside apparatus 20 are installed in multiple locations for each functional part and each functional part is connected to each other communicably by wired or wireless means is also possible. For example, the imager 22, the notification interface 21, the memory 23, and the controller 24 may be installed at different positions on the same strut 20A, or they may be distributed across multiple struts 20A.

For example, in the embodiment described above, it was explained that if the posture of the strut 20A changes from the basic posture due to an unintended factor such as a vehicle (motorcycle) collision, the capturing range R1 of the video camera 22A shifts to R2 accordingly. However, factors that can shift the capturing range R1 of the video camera 22A are not limited to this. Changes over time in the mounting area of the video camera 22A, or collisions of people, animals, or objects with the video camera 22A itself can also cause the capturing range R1 to shift.

For example, an embodiment in which a general purpose computer functions as the roadside apparatus 20 according to the above embodiment can also be implemented. Specifically, a program in which processes for realizing the functions of the roadside apparatus 20 according to the above embodiment are written may be stored in a memory of a general purpose computer, and the program may be read and executed by a processor. Accordingly, the present disclosure can also be implemented as a program executable by a processor, or a non-transitory computer readable medium storing the program.

1. A roadside apparatus comprising:
a notification interface;
an imager;
a memory; and
a controller configured to:
store in the memory a reference image captured by the imager with the roadside apparatus installed in a reference posture;
calculate an amount of deviation between a capturing range of an image captured by the imager after the reference image is stored and a capturing range of the reference image; and
notify a server of information encouraging a repair to a posture of the roadside apparatus via the notification interface in a case in which the amount of deviation is equal to or greater than a threshold.

2. The roadside apparatus according to claim 1, wherein the reference posture is a posture in which a strut supporting the roadside apparatus points in a vertical direction.

3. The roadside apparatus according to claim 1, wherein the amount of deviation is a percentage obtained by dividing an area of a range in which the capturing range of the image captured by the imager after the reference image is stored does not overlap the capturing range of the reference image by an area of the capturing range of the reference image.

4. The roadside apparatus according to claim 1, wherein the controller is configured to continue capturing an image using the imager in a case in which the amount of deviation is less than the threshold.

5. A notification method performed by a roadside apparatus, the notification method comprising:
storing a reference image captured with the roadside apparatus installed in a reference posture;
calculating an amount of deviation between a capturing range of an image captured after the reference image is stored and a capturing range of the reference image; and
notifying a server of information encouraging a repair to a posture of the roadside apparatus in a case in which the amount of deviation is equal to or greater than a threshold.
